(19) United States
(12) Patent Application Publication
(10) Pub. No.: US 2026/0184224 A1
(43) Pub. Date: Jul. 2, 2026

(54) SYSTEM FOR CHARGE MANAGEMENT AND METHOD THEREOF

(71) Applicants: HYUNDAI MOTOR COMPANY, Seoul (KR); KIA CORPORATION, Seoul (KR); Myongji University Industry and Academia Cooperation Foundation, Yongin-si (KR)

(72) Inventors: Jae Hyuk Choi, Hwaseong-si (KR); Jin Su Jang, Hwaseong-si (KR); Min Ho Shin, Yongin-si (KR); Kyung Chan Kim, Seoul (KR); Su Won Park, Seoul (KR)

(73) Assignees: HYUNDAI MOTOR COMPANY, Seoul (KR); KIA CORPORATION, Seoul (KR); Myongji University Industry and Academia Cooperation Foundation, Yongin-si (KR)

(21) Appl. No.: 19/228,119

(22) Filed: Jun. 4, 2025

(30) Foreign Application Priority Data
Dec. 27, 2024 (KR) 10-2024-0199193

(51) Int. Cl. B60L 53/66; B60L 53/53; B60L 53/57; H02J 7/34

(52) U.S. Cl. CPC B60L 53/665; B60L 53/53; B60L 53/57; H02J 7/342; H02J 2105/37

(57) ABSTRACT

The present disclosure relates to a charging management system and a method therefor. The system may include at least one first electric vehicle configured to supply power to at least one second electric vehicle that requests a charging service, and a charging management server configured to manage a charging service based on a communication protocol of the first electric vehicle and the second electric vehicle. The charge management server may be configured to support payment for the charging service by verifying a certificate of the communication protocol for the charging service.

### CROSS-REFERENCE TO RELATED APPLICATION(S)

This application claims priority to and the benefit of Korean Patent Application No. 10-2024-0199193, filed with the Korean Intellectual Property Office on Dec. 27, 2024, the entire contents of which are incorporated herein by reference.

### TECHNICAL FIELD

The present disclosure relates to a charging management system and a method therefor, and more specifically, to a technique for supporting a smart charging service during V2V-based charging.

### BACKGROUND

Electric vehicles (EV) currently under development use batteries to power their motors. Accordingly, these electric vehicles produce less air pollutants such as exhaust gases and noise, have fewer breakdowns, a longer lifespan, and are easier to drive as compared to conventional gasoline engine vehicles. An electric vehicle charging system may be basically defined as a system that charges a battery mounted on an electric vehicle using an electric power of a commercial power distribution grid or an energy storage device. This electric vehicle charging system may take many different forms according to a type of electric vehicle. For example, the electric vehicle charging system may include a conductive charging system using a cable or a contactless wireless power transfer system.

Recently, as use of electric vehicles increases, an infrastructure for a charging system may be useful. In general, electric vehicles are charged using stationary chargers. For example, an electric vehicle that wants to charge can go to an electric charging station to be charged. However, there are fewer electric vehicle charging stations in the country compared to other types of charging stations, so there may be location restrictions. In particular, suburban areas have fewer electric charging stations, which may pose problems for electric vehicle driving. Such an issue may cause electric vehicle owners to feel anxious about charging.

To solve this issue, V2V-based charging service technology is being developed and has been provided in some areas since 2021, and this V2V-based charging service was implemented free of charge, and as a result, it was confirmed that user convenience was improved. However, the conventional V2V-based charging service has a problem that not only does it not support payment services, but it also does not provide services such as dispatch management of electric power supply vehicles.

As described above, in order to meet a rapidly increasing demand for electric vehicles and diverse charging needs, V2V-based charging technology that provides smart charging services may be useful.

### SUMMARY

An embodiment of the present disclosure provides a charging management system and a method therefor, capable of supporting a smart charging service by monitoring a customer vehicle and a power supply vehicle.

An embodiment of the present disclosure provides a charging management system and a method therefor, capable of supporting a charging payment service for a customer vehicle.

The technical objects of the present disclosure are not limited to the objects mentioned above, and other technical objects not mentioned may be understood by those skilled in the art from the description of the claims.

An embodiment of the present disclosure provides a charging management system including at least one first electric vehicle configured to supply power to at least one second electric vehicle that requests a charging service, and a charging management server configured to manage a charging service based on a communication protocol of the first electric vehicle and the second electric vehicle. The charging management server may be configured to support payment for the charging service by verifying a certificate of the communication protocol for the charging service.

In an example embodiment of the present disclosure, the communication protocol may support at least one of an open charge point protocol (OCPP), ISO 15118, or IEC 61850.

In an example embodiment of the present disclosure, the first electric vehicle is configured to include a communication module configured to support the communication protocol for transmitting and receiving information with respect to the second electric vehicle and the charging management server, a control module configured to verify validity of a certificate chain received from the second electric vehicle, and a charging module configured to perform the payment while supplying power to the second electric vehicle, in response to a case where the certificate chain is valid.

In an example embodiment of the present disclosure, the communication module may be configured to receive a request message for the charging service from the charging management server.

In an example embodiment of the present disclosure, in response to a case where the charging module is connected to the second electric vehicle, the control module may be configured to determine whether an identifier of the received request message and an identifier of the certificate chain match.

In an example embodiment of the present disclosure, in response to a case where the control module determines that the identifier of the received request message and the identifier of the certificate chain match, the communication module may be configured to transmit the certificate chain to the charging management server, and the charging module is configured to supply power to the second electric vehicle.

In an example embodiment of the present disclosure, in response to a case where the charging module completes the power supply, the control module may be configured to generate charging service information, and the communication module may be configured to transmit the charging service information to the charging management server, and to receive a payment request message from the second electric vehicle.

In an example embodiment of the present disclosure, the charge management server may be configured to include a server communication module configured to support the communication protocol for transmitting and receiving information with respect to the first electric vehicle, a memory configured to store at least one command, and a processor configured to execute the at least one command. The processor may be configured to verify validity of the received certificate chain, to control the first electric vehicle to perform the power supply according to a verification result, and to perform the payment in response to completing the power supply.

In an example embodiment of the present disclosure, the processor may be configured to generate payment information based on the payment request message received from the first electric vehicle.

In an example embodiment of the present disclosure, the service communication module is configured, in response to receiving the payment request message, to transmit the charging service information and the payment information to an external server.

Another embodiment of the present disclosure provides a charging management method for a charging management system. The method includes supplying power by a first electric vehicle, requesting a charging service and receiving power from the first electric vehicle by a second electric vehicle, managing the charging service based on a communication protocol of the first electric vehicle and the second electric vehicle by a charging management server, and supporting payment for the charging service by verifying a certificate of the communication protocol for the charging service by the charging management server.

In another example embodiment of the present disclosure, the communication protocol may support at least one of an open charge point protocol (OCPP), ISO 15118, or IEC 61850.

In another example embodiment of the present disclosure, the supplying of the power may include supporting, by a processor, the communication protocol for transmitting and receiving information with respect to the second electric vehicle and the charging management server, verifying, by the processor, validity of a certificate chain received from the second electric vehicle, supplying, by the processor, power to the second electric vehicle in response to a case where the certificate chain is valid, receiving, by the processor, a payment request message from the second electric completed, and performing the payment by the processor.

In another example embodiment of the present disclosure, the supporting of the communication protocol may include receiving, by the processor, a request message for the charging service from the charging management server.

In another example embodiment of the present disclosure, the verifying of the validity of the certificate chain may include determining, by the processor, whether an identifier of the received request message and an identifier of the certificate chain match.

In another example embodiment of the present disclosure, the supplying of the power to the second electric vehicle transmitting, by the processor, the certificate chain to the charging management server, and supplying, by the processor, power to the second electric vehicle.

In another example embodiment of the present disclosure, the supplying of the power may include generating, by the processor, charging service information, determining, by the processor, whether an identifier of the received request message and an identifier of the certificate chain match, transmitting, by the processor, the certificate chain to the charging management server, and supplying, by the processor, power to the second electric vehicle.

In another example embodiment of the present disclosure, the supplying of the power may further include transmitting, by the processor, changed status information of the first electric vehicle to the charging management server.

In another example embodiment of the present disclosure, the managing the charging service may include supporting, by the processor, the communication protocol for transmitting and receiving information with respect to the first electric vehicle, verifying, by the processor, validity of the received certificate chain, controlling, by the processor, the first electric vehicle to perform the power supply according to a verification result, and performing, by the processor, the payment in response to completing the power supply.

In another example embodiment of the present disclosure, the performing of the payment generating, by the processor, payment information based on the payment request message received from the first electric vehicle, and transmitting, by the processor, the charging service information and the payment information to an external server.

According to the present disclosure (e.g., technique), it may be possible to improve convenience of electric vehicle users by providing a smart charging service.

Furthermore, according to the present disclosure (e.g., technique), it may be possible to solve location constraints for electric vehicle charging.

Furthermore, according to the present disclosure (e.g., technique), it may be possible to improve reliability of payment for electric vehicle charging.

Furthermore, various effects which may be directly or indirectly identified through the present specification may be provided.

### BRIEF DESCRIPTION OF THE DRAWINGS

FIG. 1 illustrates an example charging management system.

FIG. 2 illustrates a block diagram of an example charging management server.

FIG. 3 illustrates an example first electric vehicle.

FIGS. 4, 5, 6, and FIG. 7 illustrate a flowchart for describing an example charging management method.

FIG. 8 illustrates an example of status information.

FIG. 9 illustrates an example of request information.

FIG. 10 illustrates an example of response information.

FIG. 11 illustrates an example of charging service information.

FIG. 12 illustrates a block diagram showing an example computing system.

### DETAILED DESCRIPTION

Hereinafter, some example embodiments of the present disclosure will be described in detail with reference to exemplary drawings. It should be noted that in adding reference numerals to constituent elements of each drawing, the same constituent elements include the same reference numerals as possible even though they are indicated on different drawings. In describing an example embodiment of the present disclosure, when it is determined that a detailed description of the known configuration or function associated with the example embodiment of the present disclosure may obscure the gist of the present disclosure, it may be omitted.

In describing constituent elements according to an example embodiment of the present disclosure, terms such as first, second, A, B, (a), and (b) may be used. These terms are for distinguishing the constituent elements from other constituent elements, and the nature, sequences, or orders of the constituent elements are not limited by the terms. Furthermore, terms used herein including technical scientific terms have the same meanings as those which are generally understood by those skilled in the technical field to which an example embodiment of the present disclosure pertains (e.g., those skilled in the art) unless they are differently defined. Terms defined in a generally used dictionary shall be construed to have meanings matching those in the context of a related art, and shall not be construed to have idealized or excessively formal meanings unless they are defined in the present specification.

An electric vehicle (EV) defined in the present disclosure may refer to an automobile defined in 49 code of federal regulations (CFR) 523.3, etc. The electric vehicle may be used on a highway and powered by electricity supplied by an on-board energy storage device, such as a battery capable of being recharged from an external power source. The power source may include residential or a public electric service or an on-board vehicle fuel-powered generator.

Furthermore, such an electric vehicle may include a hybrid electric vehicle (HEV) and a plug-in hybrid electric vehicle (PHEV). Herein, the HEV may have an engine as a main power source and a motor as an auxiliary power source. The PHEV may have a motor as a main power source and an engine that is used in response to a case where a battery thereof is discharged.

A smart charging service in the present disclosure may indicate a service that assigns an ID to an electric vehicle user and provides a charging history, charger (e.g., power supply vehicle) position information, charger (e.g., power supply vehicle) information, payment, etc. Hereinafter, the smart charging service will be referred to as a charging service.

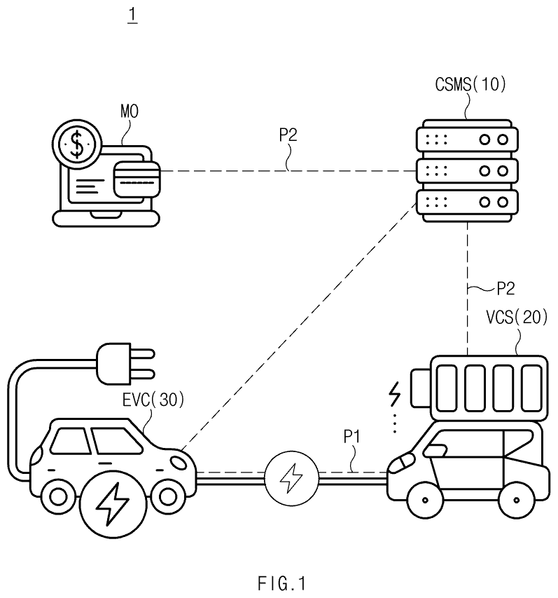

Hereinafter, various example embodiments of the present disclosure will be described in detail with reference to FIG. 1 to FIG. 12.

FIG. 1 illustrates an example V2V-based charging management system 1 (hereinafter, charging management system).

Referring to FIG. 1, the charging management system 1 may include a charging management server 10, a first electric vehicle 20, and a second electric vehicle 30.

The first electric vehicle 20 (VCS) may be at least one electric vehicle configured to supply an electric power. That is, the first electric vehicle 20 (VCS) may be a mobile charger capable of performing (e.g., all) functions of a conventional charger.

The second electric vehicle 30 (EVC) may be at least one electric vehicle configured to request a charging service and receive power from the first electric vehicle 20. The second electric vehicle 30 (EVC) may be configured to recognize the first electric vehicle 20 as a mobile charger and perform a charging process.

The charging management server 10 may be configured to manage the charging service by monitoring the first electric vehicle 20 and the second electric vehicle 30.

For example, the charging management server 10 may be a server of a charging station management system (CSMS) including an open charge point protocol (OCPP) and a charging point operator (CPO).

The CPO may refer to a company or organization that has authority to position a charging station to allow physical access to the charging station. Accordingly, the charge management server 10 may be configured to manage the first electric vehicle 20 and grant authority for the charging process performed in each electric vehicle using information and communication technology.

The charging management server 10 may be configured to dispatch the first electric vehicle 20 corresponding to a request from the second electric vehicle 30 based on status information of the first electric vehicle 20.

The charging management server 10 may be configured to manage the charging service based on a communication protocol of the first electric vehicle 20 and the second electric vehicle 30. Then, the charging management server 10 may be configured to support payment for the charging service by verifying a certificate of the communication protocol for the charging service.

Herein, the certificate may refer to an electronic document that binds a public key (PK) to an ID through a digital signature. Public key infrastructure (PKI) may refer to a system for generating, storing, redistributing, and revoking digital signatures that are used to verify that a specific public key belongs to a particular person or entity.

A certificate chain may be provided in (e.g., injected into) the first electric vehicle 20 and the second electric vehicle 30 from an original equipment manufacturer (OEM). The OEM may refer to a server operated by an electric vehicle manufacturer, and may refer to a top-level certificate authority (CA) that issues OEM root certificates. For better understanding and ease of description, it has been described that the OEM injects the certificate chain, but the present disclosure is not limited thereto. In the instant case, the certificate chain may be referred to as a contract certificate chain, and may be formed based on signatures. For example, a certificate for an OEM subordinate entity may be generated by signing a public key of the OEM subordinate entity with a private key of an OEM root certificate. By bundling the OEM root certificate and the certificate of the OEM subordinate entity, a certificate chain may be created.

Mobility operator (MO) may refer to a server operated by a charging business operator, and may include a certificate provisioning service (CPS). A charging business operator (MO) may be a business operator that provides charging services by entering into a B2C contract with electric vehicle users. Furthermore, the charging operator (MO) may share information related to the certificate chain with the OEM. Accordingly, the charging business operator (MO) may verify validity of certificates of the first electric vehicle 20 and the second electric vehicle 30.

The CPS may refer to an entity that provides an electric vehicle certificate installation service, and plays a role in providing billing and other value-added services to customers. The CPS may be a special type of charging operator (MO) or may be implemented in a combined form with a charging operator (MO).

Herein, the communication protocol may support at least one of open charge point protocol (OCPP), ISO 15118, or IEC 61850. For example, the charging management server 10 and the first electric vehicle 20 may support the OCPP (P2). Furthermore, the first electric vehicle 20 and the second electric vehicle 30 may support at least one of ISO 15118 or IEC 61850 (P1).

The ISO 15118 may be a communication protocol between electric vehicles and chargers, and may support plug and charge (PnC) functionality that requires automatic identification and authentication. In the present disclosure, the ISO 15118 may be a communication protocol between the first electric vehicle 20 and the second electric vehicle 30.

The PnC may refer to a process by which authentication, authorization, load control, and payment are (e.g., automatically) performed in response to a case where an electric vehicle user simply plugs the electric vehicle into a charger without (e.g., requiring) any additional user interaction. Alternatively, the PnC may refer to an identification and authorization mode for such automated processes. The PnC may allow an electric vehicle user to charge a vehicle without hassle of approval.

The ISO 15118 may enable standardized authentication between electric vehicles and chargers using the public key infrastructure (PKI) used on the Internet. Furthermore, the ISO 15118 may enable secure transmission of communication data between electric vehicles and chargers through message encryption in addition to most basic certification.

The open charge point protocol (OCPP) is an international open charging communication protocol adopted as a standard in more than 50 countries. The OCPP is an open charging communication protocol created by open charge alliance (OCA), and version 2.0.1 is currently being distributed, which is a representative internationally accepted electric vehicle charging infrastructure protocol. In the present disclosure, the OCPP may be a communication protocol between the first electric vehicle 20 and the charging management server 10.

In Korea, the Ministry of Environment made OCPP 1.6 certification mandatory for charger distribution projects in 2022, making it more widespread. OCPP 2.0.1 supports a communication environment with enhanced security compared to previous versions. For example, the OCPP 2.0.1 may have characteristics that are more suitable for smart charging techniques such as PnC and wireless charging.

Recently, the need for standardization of the “charging communication protocol,” which stipulates a format and transmission/reception method of information exchange between chargers and electric vehicles, has been raised. In order to fully expand electric vehicles, a standard protocol would be useful that facilitates (e.g., efficient) construction of a charging facility network and operation in conjunction with a power grid.

To address such problems, the present disclosure proposes the charging management system 1 that simultaneously supports ISO 15118 and OCPP. Accordingly, the charging management system 1 may provide an optimized smart charging service.

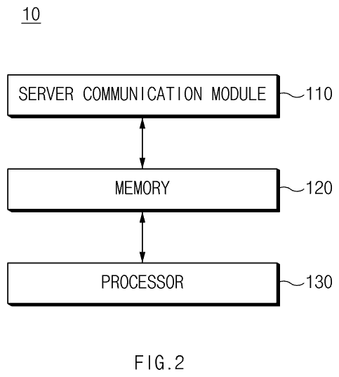

A detailed description of the charging management system 1 will be described with reference to FIG. 2 to FIG. 11.

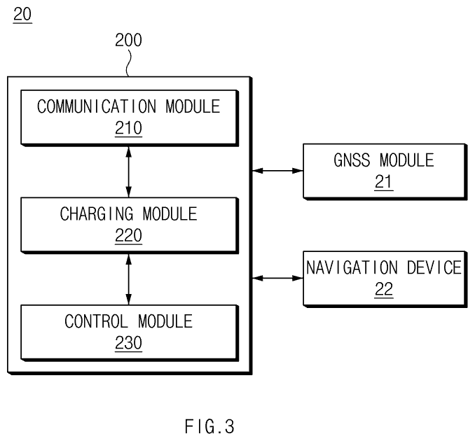

FIG. 2 illustrates a block diagram of an example charging management server 10, and FIG. 3 illustrates an example first electric vehicle 20.

Referring to FIG. 2, the charging management server 10 may include a server communication module 110, a memory 120, and a processor 130.

The server communication module 110 may be configured to support a communication protocol for transmitting and receiving information with respect to the first electric vehicle 20. For example, the server communication module 110 may be configured to support OCPP.

The memory 120 may be configured to store at least one command. Furthermore, the memory 120 may be configured to store data transmitted and received through the server communication module 110.

The processor 130 may be configured to (e.g., access the memory and) execute at least one command. For example, the processor 130 may be configured to generate request information based on information related to a second electric vehicle (EVC). Herein, the request information may include at least one of a user identifier of the second electric vehicle (EVC), user information, battery information, position information, or a request message. For example, in response to a case where the server communication module 110 receives a request message from the second electric vehicle (EVC), the processor 130 may be configured to generate request information.

The processor 130 may be configured to verify validity of a certificate for a communication protocol received from the first electric vehicle 20. For example, the server communication module 110 may be configured to receive a certificate chain according to ISO 15118 injected into the first electric vehicle 20 from the first electric vehicle 20. Thereafter, the processor 130 may be configured to verify validity of the certificate chain according to ISO 15118. For example, in response to a case where the processor 130 determines that the certificate is valid, the server communication module 110 may be configured to receive status information from the first electric vehicle 20. Herein, the status information may include at least one of the identifier of the first electric vehicle 20, charger information, position information, price information, communication protocol information, or user customer information.

Furthermore, the processor 130 may be configured to verify the validity of the certificate chain received from the second electric vehicle (EVC). For example, the server communication module 110 may receive a certificate chain according to ISO 15118 injected into the second electric vehicle (EVC) from the second electric vehicle (EVC). Thereafter, the processor 130 may be configured to verify validity of the certificate chain according to ISO 15118. The processor 130 may be configured to control the first electric vehicle 20 to supply power to the second electric vehicle (EVC) based on a verification result thereof. For example, in response to determining that the certificate is valid, the processor 130 may be configured to control the first electric vehicle 20 to supply power to the second electric vehicle (EVC).

The validity of the certificate chain of the second electric vehicle (EVC) may be determined based on the verification result received from the charging operator (MO). For example, in response to a case where the server communication module 110 transmits a received certificate chain to a server of the charging operator (MO), the server of the charging operator (MO) may be configured to perform validation of the certificate chain. In response to a case where the server of the charging operator (MO) determines that the certificate chain is valid, a result thereof may be received by the server communication module 110. Thereafter, the processor 130 may be configured to determine that the certificate chain of the second electric vehicle (EVC) is valid. Meanwhile, the validity of the certificate chain of the first electric vehicle 20 may be determined based on the verification result received from a CPO server.

The processor 130 may be configured to select the first electric vehicle 20 based on the request information and the status information. Thereafter, the server communication module 110 may be configured to transmit the request information to the selected first electric vehicle 20.

The processor 130 may be configured to select the first electric vehicle 20 positioned closest to the second electric vehicle (EVC) by considering positions of the first electric vehicle 20 and the second electric vehicle (EVC). For example, the processor 130 may be select a candidate group of first electric vehicles 20 that matches the request information of the second electric vehicle (EVC) among a plurality of first electric vehicles 20. Herein, the candidate group may be a group of the first electric vehicle 20 whose status information, charger information, communication protocol information, etc. match the requested information. That is, the processor 130 may be configured to select a candidate group of the first electric vehicle 20 that matches the second electric vehicle (EVC) in terms of a charging terminal, a communication protocol, a required charging amount, etc.

Thereafter, the processor 130 may be selected to select the first electric vehicle 20 positioned closest to the second electric vehicle (EVC) among the candidate group in priority order. Thereafter, the processor 130 may be configured to transmit request information to the selected first electric vehicle 20 through the server communication module 110. Thereafter, the server communication module 110 may be configured to receive a response corresponding to the request information from the first electric vehicle 20. In the instant case, in response to a case where there is a response to acceptance, the processor 130 may be configured to dispatch the first electric vehicle 20 to the second electric vehicle (EVC). That is, the processor 130 may be configured to control the first electric vehicle 20 to move to a position for charging the second electric vehicle (EVC). That is, the charging management server 10 may be configured to support a smart charging service by monitoring the first electric vehicle 20 and the second electric vehicle 30.

Once the power supply is complete, the processor 130 may be configured to perform the payment. The processor 130 may be configured to generate payment information based on a payment request message received from the first electric vehicle 20. Herein, the payment information may include a payment amount, a payment method, payment customer information, a payment request message, etc. For example, in response to receiving a payment request message through the server communication module 110, the processor 130 may be configured to generate the payment information. Thereafter, the processor 130 may be configured to transmit charging service information and payment information to an external server. Herein, the external server may include a server of the charging operator (MO) and a CPS, etc. That is, the charging management server 10 may be configured to support a charging payment service for a customer vehicle.

Referring to FIG. 3, the first electric vehicle 20 may be equipped with a charging management module 200, and the charging management module 200 may include a communication module 210, a charging module 220, and a control module 230.

The communication module 210 may support a communication protocol for transmitting and receiving information with respect to the second electric vehicle (EVC) and the charging management server 10. For example, the communication module 210 may support OCPP in response to transmitting and receiving information with the charging management server 10. Meanwhile, the communication module 210 may be configured to support at least one of ISO 15118 or IEC 61850 in response to transmitting and receiving information with respect to the second electric vehicle (EVC).

In response to a case where the charging module 220 completes a power supply, the communication module 210 may be configured to transmit charging service information to the charging management server 10. Herein, the charging service information may be a service description record (SDR) of OCPP, and may include at least one of a supply identifier, charging position information, power supply information, charging communication protocol information, charging rate information, or charging time information. Together therewith, the communication module 210 may be configured to receive a payment request message from the second electric vehicle (EVC).

Furthermore, in response to a case where the charging module 220 completes a power supply, the communication module 210 may be configured to transmit changed status information of the first electric vehicle 20 to the charging management server 10. For example, the communication module 210 may be configured to transmit changed information including a changed battery capacity, a charging status, etc. of the first electric vehicle 20 to the charging management server 10.

The charging module 220 may be configured to supply power to a second electric vehicle (EVC). The charging module 220 may be configured to perform payment for a charging service through the communication module 210. Herein, the payment method may include a PnC method.

The control module 230 may be configured to generate response information corresponding to request information. For example, the communication module 210 may be configured to receive request information including a request message for a charging service from the charging management server 10. Herein, the request message may be a message transmitted by the second electric vehicle (EVC) to the charging management server 10. Thereafter, the control module 230 may be configured to generate response information that accepts the request information. Herein, the response information may include at least one of a response message, dispatch information, expected charging fee information, or expected charging time information. On the other hand, the control module 230 may be configured to generate a rejection message rejecting the requested information. For example, in response to a case where there is another second electric vehicle (EVC) reserved for the first electric vehicle 20, the control module 230 may be configured to generate a rejection message, and the communication module 210 may transmit the rejection message to the charging management server 10.

The control module 230 may determine dispatch information based on a position of the second electric vehicle (EVC) that transmitted the request information. Herein, the dispatch information may include an expected dispatch time, an expected travel distance, and an expected travel path. For example, the control module 230 may be configured to determine dispatch information based on position information of the second electric vehicle (EVC) included in the request information and current position information of the first electric vehicle 20. The current position information of the first electric vehicle 20 may be received from a GNSS module 21 equipped in the first electric vehicle 20. A navigation device 22 equipped in the first electric vehicle 20 may guide a driver of the first electric vehicle 20 to a charging position of the second electric vehicle (EVC) based on the determined dispatch information. Herein, the charging position may be a position requested by the second electric vehicle (EVC) or a position provided by the charging management server 10. That is, a charging process may proceed by dispatching the first electric vehicle 20 to the second electric vehicle 30.

In a case where the charging module 220 is connected to the second electric vehicle (EVC), the control module 230 may be configured to verify validity of the certificate chain received from the second electric vehicle (EVC). That is, in response to the case of being connected to the second electric vehicle (EVC), the control module 230 may be configured to determine whether an identifier of the received request message and an identifier of the certificate chain match. For example, in response to the case where the charging module 220 is connected to the second electric vehicle (EVC), the control module 230 may be configured to receive a certificate chain from the second electric vehicle (EVC) through the communication module 210. Thereafter, the control module 230 may be configured to determine whether an eMobility Account ID (eMAID), which is the identifier included in the request message, matches an eMAID, which is the identifier included in the certificate chain. Herein, eMAID may be an identifier for a certificate according to ISO 15118.

In response to a case where the control module 230 determines that the identifier of the request message and the identifier of the certificate chain match, the communication module 210 may be configured to transmit the certificate chain to the charging management server 10 along with a message indicating that it is connected to the second electric vehicle (EVC). Thereafter, the charging management server 10 may be configured to verify validity of the certificate chain of the second electric vehicle (EVC).

Furthermore, in response to a case where the control module 230 determines that the certificate chain is valid, the charging module 220 may be configured to perform a payment process while supplying power to the second electric vehicle (EVC). In response to a case where the charging module 220 completes a power supply, the control module 230 may be configured to generate charging service information. Together therewith, the communication module 210 may be configured to transmit charging service information to the charging management server 10. Then, the communication module 210 may be configured to receive a payment request message from the second electric vehicle (EVC). Thereafter, the communication module 210 may be configured to transmit the received payment request message to the charging management server 10. That is, a payment process may proceed by transmitting the payment request message to the charging management server 10.

As described above, the charging management system 1 according to the present disclosure may be configured to provide a smart charging service, thereby improving convenience of electric vehicle users. Furthermore, the charging management system 1 may be configured to solve location constraints of electric vehicle charging and improve reliability of payment for electric vehicle charging.

Furthermore, the charging management system 1 may be expanded into a peer to peer (P2P) charging sharing service utilizing a platform.

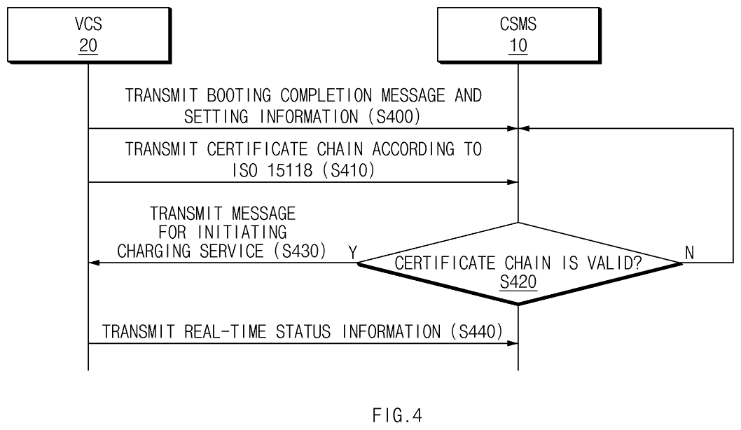

FIG. 4 to FIG. 7 each illustrate a flowchart for describing an example V2V-based charging management method. FIGS. 4 to 7 may illustrate methods by which the charging management system 1 of FIG. 1 operates. Accordingly, identical or similar configurations are indicated with identical or similar reference numerals, and duplicate descriptions may be omitted. Then, for better understanding and ease of description, the charge management methods of FIG. 4 to FIG. 7 follow ISO 15118 protocol and OCCP. However, this is merely an example of the present disclosure, and the present disclosure is not limited thereto.

Referring to FIG. 4, at operation S400, the first electric vehicle 20 may be configured to transmit a booting completion message and setting information to the charging management server 10. Herein, the booting completion message may be a message indicating that the first electric vehicle 20 is capable of charging and operating. That is, the booting completion message may be a message indicating that the first electric vehicle 20 is able to receive a request for a charging service from the second electric vehicle (EVC). The setting information may include setting information of a charger equipped in the first electric vehicle 20.

At operation S410, the first electric vehicle 20 may be configured to transmit a certificate chain according to ISO 15118 to the charging management server 10.

At operation S420, the charging management server 10 may be configured to verify validity of the certificate for ISO 15118 received from the first electric vehicle 20.

In response to a case where the charging management server 10 determines that the certificate is valid, at operation S430, the charging management server 10 may be configured to transmit a message for initiating a charging service to the first electric vehicle 20. That is, the message for initiating the charging service may be a message that the charging management server 10 may dispatch the second electric vehicle 30 to the first electric vehicle 20.

At operation S440, because the certificate of the first electric vehicle 20 is valid, the first electric vehicle 20 may be configured to transmit real-time status information of the first electric vehicle 20 to the charging management server 10 at any time. For example, the real-time status information may be transmitted at regular intervals or may be transmitted in response to a case where the status information changes.

According to the process described above, the first electric vehicle 20 may be configured to initiate the charging process.

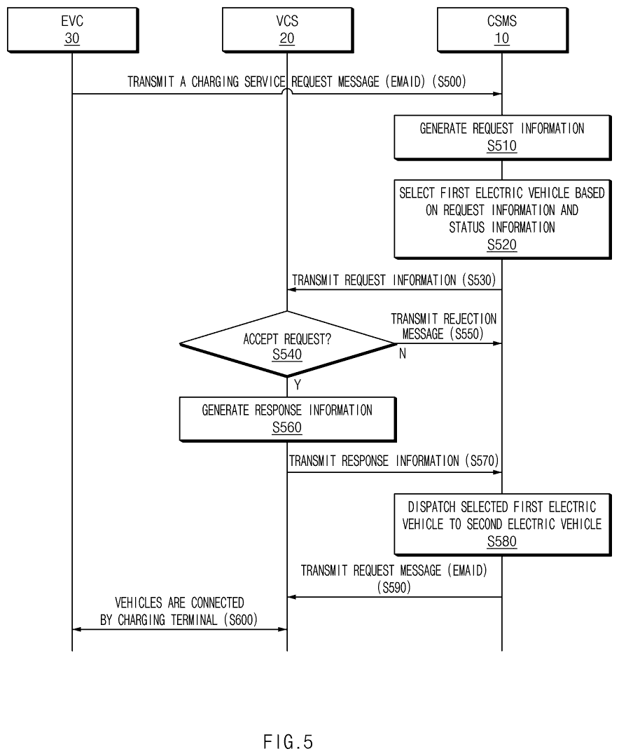

Referring to FIG. 5, at operation S500, the second electric vehicle 30 may be configured to transmit a charging service request message (eMAID) to the charging management server 10.

At operation S510, the charging management server 10 may be configured to generate request information based on the request message of the second electric vehicle 30.

At operation S520, the charging management server 10 may be configured to select the first electric vehicle 20 based on the request information and status information.

At operation S530, the charging management server 10 may be configured to transmit the request information to the selected first electric vehicle 20.

At operation S540, the first electric vehicle 20 may be configured to accept or reject the request information according to a current status. For example, in response to a case where there is another second electric vehicle EVC reserved for the first electric vehicle 20, the first electric vehicle 20 may be configured to reject it.

In response to a case where the first electric vehicle 20 rejects the request information, the first electric vehicle 20 may be configured to transmit a rejection message to the charging management server 10 at operation S550.

At operation S560, in response to accepting the request information, the first electric vehicle 20 may be configured to generate response information including dispatch information based on a position of the second electric vehicle 30. That is, the first electric vehicle 20 may be configured to generate response information corresponding to the request information.

At operation S570, the first electric vehicle 20 may be configured to transmit the response information to the charging management server 10.

At operation S580, the charging management server 10 may be configured to dispatch the selected first electric vehicle 20 to the second electric vehicle 30 based on the response information.

In response to a case where the dispatch of the first electric vehicle 20 is completed, at operation S590, the charging management server 10 may be configured to transmit a request message (eMAID) to the first electric vehicle 20. The request message (eMAID) may be information including identifier information, so the charging management server 10 may be configured to transmit the request message (eMAID) to the first electric vehicle 20 in response to a case where dispatching is completed.

Thereafter, both the first electric vehicle 20 and the second electric vehicle 30 may be moved to a charging position, and at operation S600, the first electric vehicle 20 and the second electric vehicle 30 may be connected by a charging terminal.

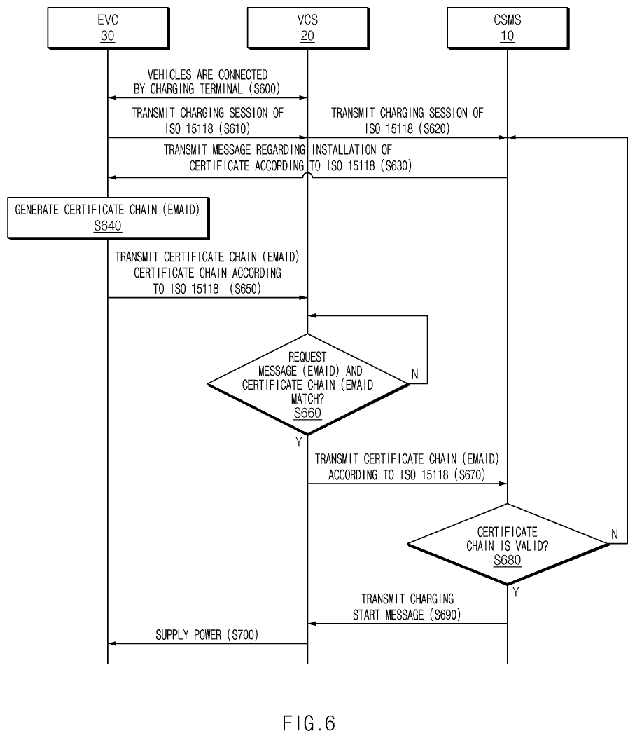

Referring to FIG. 6, at operation S600, the first electric vehicle 20 and the second electric vehicle 30 may be connected by the charging terminal.

At operation S610, the second electric vehicle 30 may be configured to transmit a charging session of ISO 15118 to the first electric vehicle 20. Thereafter, at operation S620, the first electric vehicle 20 may be configured to transmit the charging session of ISO 15118 to the charging management server 10.

At operation S630, the charging management server 10 may be configured to transmit and receive a message to the second electric vehicle 30 regarding installation of a certificate according to ISO 15118. Herein, it may be assumed that there is no certificate pre-installed in the second electric vehicle 30. For example, the second electric vehicle 30 may be configured to transmit a certificate installation request message to the first electric vehicle 20. Thereafter, the first electric vehicle 20 may be configured to transmit the received certificate installation request message to the charging management server 10. Thereafter, the charging management server 10 may be configured to transmit a certificate installation response message responding to the certificate installation request message to the first electric vehicle 20. Thereafter, the first electric vehicle 20 may be configured to transmit the received certificate installation response message to the second electric vehicle 30.

The second electric vehicle 30 may be configured to install a certificate according to ISO 15118, and also at operation S640, the second electric vehicle 30 may also be configured to have a certificate chain according to ISO 15118 installed. Herein, the certificate chain may be generated by the CPS server, and may include eMAID, which is identifier information.

At operation S650, the second electric vehicle 30 may be configured to transmit a certificate chain to the first electric vehicle 20.

At operation S660, the first electric vehicle 20 may be configured to determine whether an identifier (eMAID) of the received request message and an identifier (eMAID) of the certificate chain match.

In response to a case where the identifier (eMAID) of the request message and the identifier (eMAID) of the certificate chain match, the first electric vehicle 20 may be configured to transmit the certificate chain to the charging management server 10 at operation S670.

At operation S680, the charging management server 10 may be configured to verify validity of the certificate chain. For example, the charging management server 10 may be configured to transmit the received certificate chain and identifier (eMAID) to a server of the charging business operator (MO). Thereafter, the server of the charging operator (MO) may be configured to perform validations of the certificate chain and the identifier (eMAID). The charging management server 10 may be configured to verify validity of the certificate chain based on a verification result thereof received from the charging operator (MO).

In response to a case where the charging management server 10 determines that the certificate chain is valid, at operation S690, the charging management server 10 may be configured to transmit a charging start message to the first electric vehicle 20. The charging start message may contain a transaction of OCPP.

At operation S700, the first electric vehicle 20 may be configured to supply power to the second electric vehicle 30 based on the charging start message.

According to the above-described process, the first electric vehicle 20 may be configured to supply power to the second electric vehicle 30.

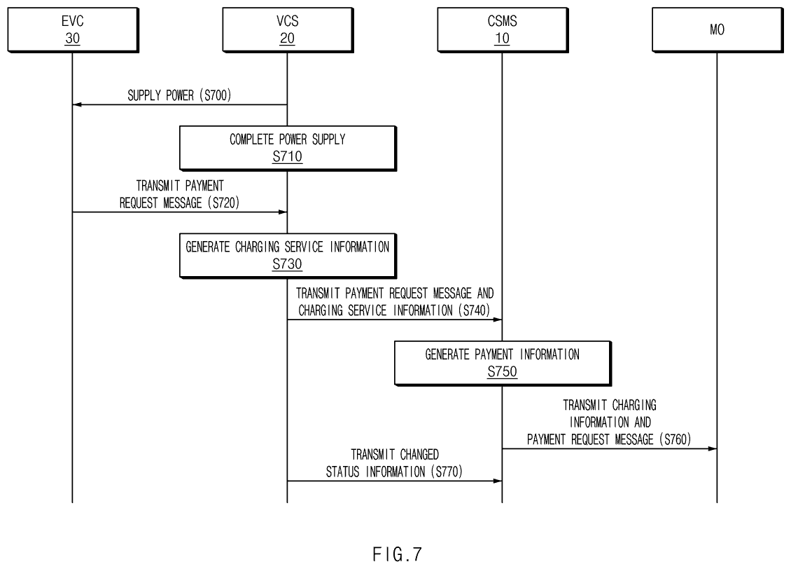

Referring to FIG. 7, at operation S700, the first electric vehicle 20 may be configured to supply power to the second electric vehicle 30 based on the charging start message.

At operation S710, the first electric vehicle 20 may be configured to complete the power supply to the second electric vehicle 30.

In response to completing the power supply, at operation S720, the second electric vehicle 30 may be configured to transmit a payment request message to the first electric vehicle 20. Together therewith, in response to completing the power supply, the charging session of ISO 15118 and the transaction of OCPP may be terminated.

At operation S730, the first electric vehicle 20 may generate charging service information.

At operation S740, the first electric vehicle 20 may be configured to transmit the received payment request message and the charging service information to the charging management server 10.

At operation S750, the charging management server 10 may be configured to generate payment information based on the payment request message received from the first electric vehicle 20.

At operation S760, the charging management server 10 may transmit charging service information and a payment request message to the server of the charging operator (MO). Accordingly, a payment process for the charging service may be performed.

At operation S770, the first electric vehicle 20 may be configured to transmit changed status information to the charging management server 10. For example, the first electric vehicle 20 may be configured to transmit changed information including a changed battery capacity, a charging status, etc. of the first electric vehicle 20 to the charging management server 10.

According to the above-described process, the charging management server 10 may be configured to initiate the payment process.

As described above, in accordance with the V2V-based charging management method according to the present disclosure, it may be possible to provide a smart charging service, thereby improving convenience of electric vehicle users. Furthermore, according to the charging management method, it may be possible to solve location constraints of electric vehicle charging and improve reliability of payment for electric vehicle charging.

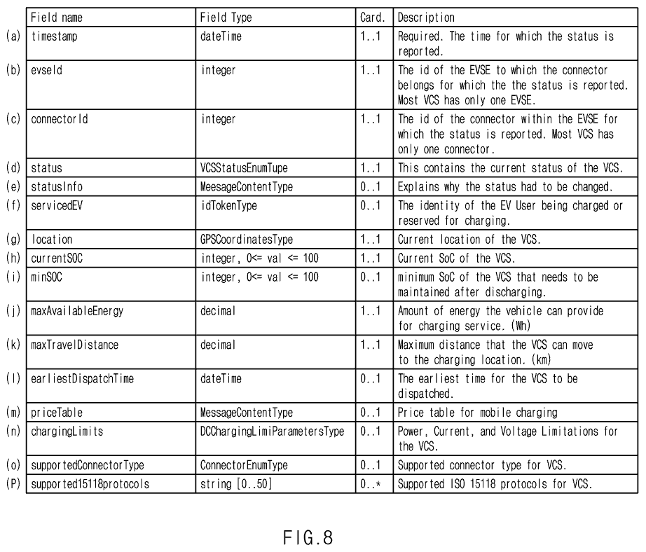

FIG. 8 illustrates an example of status information.

Referring to FIG. 8, herein, the status information may include at least one of the identifier of the first electric vehicle 20, charger information, position information, price information, communication protocol information, or user customer information. The charging management server 10 may be configured to dispatch the first electric vehicle 20 corresponding to a request from the second electric vehicle (EVC) based on status information of the first electric vehicle 20.

As shown in FIG. 8, (a) may be a current record time. For example, status information may be transmitted in real time, so it may include information related to a time it is currently being recorded.

Continuing with FIG. 8, the identifier may include information described in (b) and (c). For example, the identifier may include a charger identifier and a charging equipment identifier provided in the first electric vehicle 20. (b) may be a charger identifier. The charger identifier may include a code that identifies a charger. (c) may be a charging equipment identifier. For example, it may be a code that identifies a charging device, such as a charging terminal.

Continuing with FIG. 8, user information may include information described in (d) to (f). For example, (d) is charger usage information, which may be described as available, charging, or reserved. (e) is a reason for a change in charger usage information, in which a reason for a change in charger usage information may be described. (f) may be reserved customer information.

Continuing with FIG. 8, (g) may be a current position. For example, position information may include a current position.

Continuing with FIG. 8, charger information may include information described in (h) to (k). (h) may be a state of charge (SOC) of the battery. (i) may be a minimum maintained SOC of the battery. (j) may be a charging capacity of a battery capable of providing a maximum charging service. In the instant case, a unit of charger information may be expressed in watt-hours (Wh). (k) may be a maximum travel distance according to a charge capacity of the battery.

Continuing with FIG. 8, (l) may be a dispatchable time. For example, the dispatchable time may include a range of times during which dispatch is possible. First, the dispatchable time may be determined based on a current status of a driver of the first electric vehicle 20.

Continuing with FIG. 8, (m) may be a price tag. For example, pricing information may include a price list.

Continuing with FIG. 8, (n) may be maximum power or minimum power. Alternatively, it may be maximum voltage/current or minimum voltage/current. For example, charger information may include maximum power or minimum power. Alternatively, the charger information may include maximum voltage/current or minimum voltage/current.

Continuing with FIG. 8, (o) may be a type of charging terminal. For example, the charger information may include a charging terminal type.

Continuing with FIG. 8, (p) may be a charging communication standard protocol. For example, the communication protocol information may include a charging communication standard protocol (e.g., ISO 15118) supported by the first electric vehicle 20.

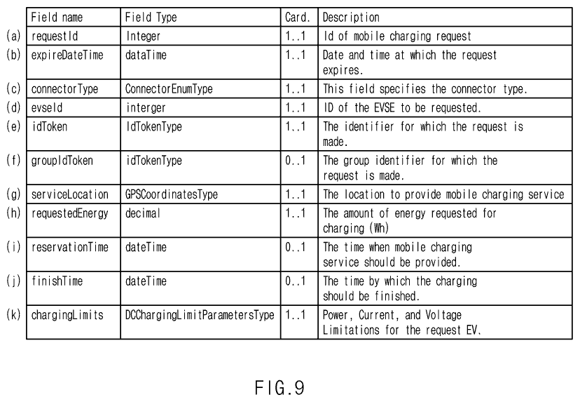

FIG. 9 illustrates an example of request information.

Referring to FIG. 9, the request information may include at least one of a user identifier of the second electric vehicle (EVC), user information, battery information, position information, or a request message. The charging management server 10 may be configured to generate request information based on information related to a second electric vehicle (EVC).

Continuing with FIG. 9, (a) may be a request unique ID. For example, the request message may include the request unique ID that identifies the request made by a user of the second electric vehicle (EVC).

Continuing with FIG. 9, (b) may be a validity period of the request. For example, a request message may include an eMAID and a request validity period.

Continuing with FIG. 9, battery information may include information described in (c) and (d). (c) may be a type of charging terminal of the second electric vehicle (EVC). (d) may be an identifier of a battery charging apparatus of the second electric vehicle (EVC).

Continuing with FIG. 9, user information may include information described in (e) and (f). (e) may be personal user information, and the personal user information may include an eMAID. (f) may be user group information.

Continuing with FIG. 9, (g) may be a charging service request position. For example, position information may include the charging service request position of the second electric vehicle (EVC).

Continuing with FIG. 9, (h) may be a required charging amount. For example, a request message may contain the requested charging amount.

Continuing with FIG. 9, the request message may include information described in (i) and (j). (i) may be a start time of the charging service. (j) may be an end time of the charging service.

Continuing with FIG. 9, (k) may be a charging communication standard protocol. For example, the communication protocol information may include a charging communication standard protocol (e.g., ISO 15118) supported by the second electric vehicle (EVC).

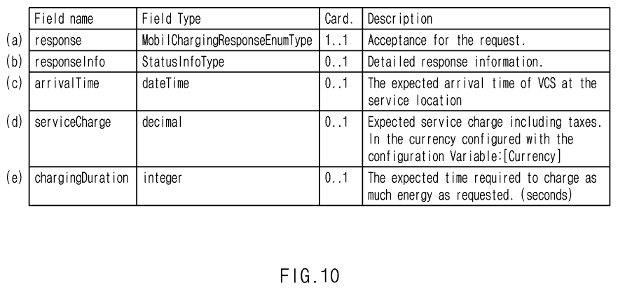

FIG. 10 illustrates an example of response information.

Referring to FIG. 10, the response information may include at least one of a response message of the first electric vehicle 20, dispatch information, expected charging fee information, or expected charging time information. The first electric vehicle 20 may be configured to generate response information corresponding to the request information.

Continuing with FIG. 10, the response message may include information described in (A) and (b). (a) may be a response code, and (b) may be detailed response information.

Continuing with FIG. 10, (c) may be an expected arrival time. For example, the dispatch information for the first electric vehicle 20 may include an expected dispatch time. Furthermore, the dispatch information may include an expected travel distance and an expected travel path.

Continuing with FIG. 10, (d) may be an estimated charging rate. For example, expected charging rate information may include an estimated charging rate.

Continuing with FIG. 10, (e) may be an expected charging time. For example, expected charging time information may include an expected charging time.

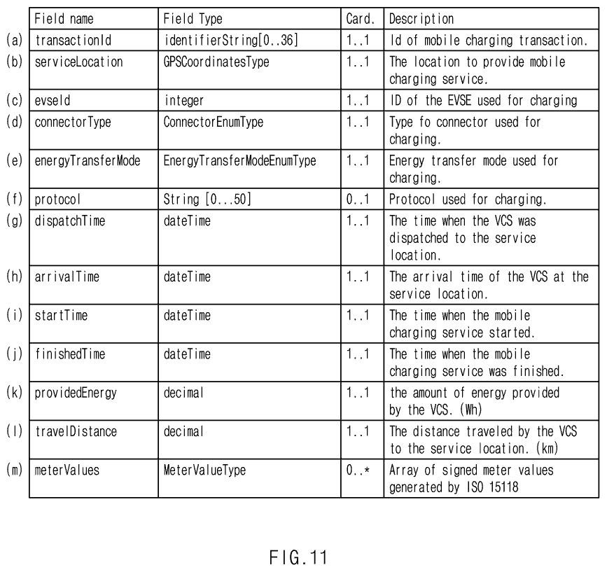

FIG. 11 illustrates an example of charging service information.

Referring to FIG. 11, herein, the charging service information may include at least one of a supply identifier, charging position information, power supply information, charging communication protocol information, charging rate information, or charging time information between the first electric vehicle 20 and the second electric vehicle 30. In response to completing supplying power to the second electric vehicle EVC, the first electric vehicle 20 may be configured to generate the charging service information. For example, the charging service information may be an SDR of OCPP.

Continuing with FIG. 11, (a) may be a transaction ID. For example, a supply identifier according to a charging communication standard protocol may include the transaction ID.

Continuing with FIG. 11, (b) may be a charging performing position. For example, charging position information may be the charging performing position.

Continuing with FIG. 11, (c) may be a charger ID. For example, the supply identifier may include the charger ID.

Continuing with FIG. 11, electric power supply information may include contents described in (d) and (e). (d) may be a charging terminal type, and (e) may be a charging power transmission type. For example, (e) may be described as a wireless power transmission or wired power transmission type.

Continuing with FIG. 11, (f) may be a charging communication standard protocol. For example, communication protocol information may include a charging communication standard protocol (e.g., ISO 15118) that supports charging of the first electric vehicle 20 and the second electric vehicle 30.

Continuing with FIG. 11, charging time information may include contents described in (g) to (j). (g) may be a departure time after dispatch. (h) may be an arrival time of a charging service performing position. (i) may be a start time of charging. (j) may be an end time of charging.

Continuing with FIG. 11, (k) may be a supply charging capacity. For example, power supply information may include a supplied charging capacity and accumulated metering values before and after charging.

Continuing with FIG. 11, (l) may be a charging dispatch distance. For example, charging position information may be the charging dispatch distance.

Continuing with FIG. 11, (m) may be a meter value type. For example, communication protocol information may include the meter value type. The meter value type may include a meter value for a charging session or a clock time series meter value.

Charging rate information may include a charging rate determined based on the power supply information described above.

Descriptions of FIGS. 8 to 11 are examples, and the present disclosure is not limited thereto.

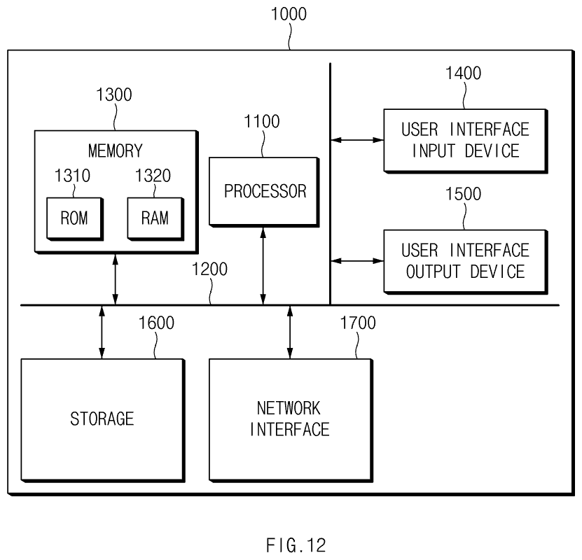

FIG. 12 illustrates a block diagram showing an example computing system 1000 of the charging management system 1 and/or the charging management server 10.

Referring to FIG. 12, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) and a random access memory (RAM).

Accordingly, steps of a method or algorithm described in connection with the example embodiments included herein may be (e.g., directly) implemented by hardware, a software module, or a combination of the two, executed by the processor 1100. The software module may reside in a storage medium (e.g., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal. Alternatively, the processor and the storage medium may reside as separate components within the user terminal.

The user interface input device 1400 may be configured to include an input device for receiving a user input.

The user interface output device 1500 may be configured to include a display that displays various information and a speaker that outputs various sounds.

The network interface 1700 may be configured to include a long-distance communication module and/or a short-distance communication module for transmitting and receiving data with respect to an external device (e.g., a server 2 or a user terminal). For example, the network interface 1700 may indicate a communication module capable of performing wireless Internet communication such as wireless LAN (WLAN), wireless broadband (Wibro), WiFi, world interoperability for microwave access (Wimax), and high speed downlink packet access (HSDPA).

The above description is illustrative of the technical idea of the present disclosure, and those skilled in the art to which the present disclosure pertains may make various modifications and variations without departing from the characteristics of the present disclosure.

Therefore, the example embodiments disclosed in the present disclosure are not intended to limit the technical ideas of the present disclosure, but to explain them, and the scope of the technical ideas of the present disclosure is not limited by these example embodiments. Technical ideas within the equivalent range should be interpreted as being included in the scope of the present disclosure.

What is claimed is:

1. A charging management system comprising:
at least one first electric vehicle configured to supply power to at least one second electric vehicle that requests a charging service; and
a charging management server configured to manage the charging service based on a communication protocol of the first electric vehicle and the second electric vehicle,
wherein the charge management server is configured to support payment for the charging service by verifying a certificate of the communication protocol for the charging service.

2. The charging management system of claim 1, wherein the communication protocol supports at least one of an open charge point protocol (OCPP), ISO 15118, or IEC 61850.

3. The charging management system of claim 1, wherein the first electric vehicle is configured to include:
a communication module configured to support the communication protocol for transmitting and receiving information with respect to the second electric vehicle and the charging management server;
a control module configured to verify validity of a certificate chain received from the second electric vehicle; and
a charging module configured to perform payment while supplying power to the second electric vehicle, when the certificate chain is valid.

4. The charging management system of claim 3, wherein the communication module is configured to receive a request message for the charging service from the charging management server.

5. The charging management system of claim 4, wherein, when the charging module is connected to the second electric vehicle, the control module is configured to determine whether an identifier of the received request message and an identifier of the certificate chain match.

6. The charging management system of claim 5, wherein, when the control module determines that the identifier of the received request message and the identifier of the certificate chain match,
the communication module is configured to transmit the certificate chain to the charging management server, and
the charging module is configured to supply power to the second electric vehicle.

7. The charging management system of claim 6, wherein, when the charging module completes the power supply,
the control module is configured to generate charging service information, and
the communication module is configured to transmit the charging service information to the charging management server and to receive a payment request message from the second electric vehicle.

8. The charging management system of claim 7, wherein
the charge management server is configured to include a server communication module configured to support the communication protocol for transmitting and receiving information with respect to the first electric vehicle;
a memory is configured to store at least one command; and
a processor is configured to access the memory and execute the at least one command, wherein the at least one command comprises
verifying validity of the received certificate chain,
controlling the first electric vehicle to perform the power supply according to a verification result, and
performing the payment when the power supply is complete.

9. The charging management system of claim 8, wherein the as least one command further comprises generating payment information based on the payment request message received from the first electric vehicle.

10. The charging management system of claim 9, wherein, when receiving the payment request message, the service communication module is configured to transmit the charging service information and the payment information to an external server.

11. A charging management method comprising:
supplying power to a first electric vehicle;
requesting a charging service and receiving power from the first electric vehicle by a second electric vehicle;
managing the charging service based on a communication protocol of the first electric vehicle and the second electric vehicle by a charging management server; and
supporting payment for the charging service by verifying a certificate of the communication protocol for the charging service by the charging management server.

12. The charging management method of claim 11, wherein the communication protocol supports at least one of an open charge point protocol (OCPP), ISO 15118, or IEC 61850.

13. The charging management method of claim 12, wherein the supplying of the power:
includes supporting, by a processor, the communication protocol for transmitting and receiving information with respect to the second electric vehicle and the charging management server;
verifying, by the processor, validity of a certificate chain received from the second electric vehicle;
supplying, by the processor, power to the second electric vehicle in response to a case where the certificate chain is valid;
receiving, by the processor, a payment request message from the second electric completed; and
performing the payment by the processor.

14. The charging management method of claim 13, wherein the supporting of the communication protocol includes receiving, by the processor, a request message for the charging service from the charging management server.

15. The charging management method of claim 14, wherein the verifying of the validity of the certificate chain includes determining, by the processor, whether an identifier of the received request message and an identifier of the certificate chain match.

16. The charging management method of claim 15, wherein the supplying of the power to the second electric vehicle includes:
transmitting, by the processor, the certificate chain to the charging management server; and
supplying, by the processor, power to the second electric vehicle.

17. The charging management method of claim 16, wherein the supplying of the power includes:
generating, by the processor, charging service information;
determining, by the processor, whether an identifier of the received request message and an identifier of the certificate chain match;
transmitting, by the processor, the certificate chain to the charging management server; and
supplying, by the processor, power to the second electric vehicle.

18. The charging management method of claim 17, wherein the supplying of the power further includes transmitting, by the processor, changed status information of the first electric vehicle to the charging management server.

19. The charging management method of claim 18, wherein the managing the charging service includes:
supporting, by the processor, the communication protocol for transmitting and receiving information with respect to the first electric vehicle;
verifying, by the processor, validity of the received certificate chain;
controlling, by the processor, the first electric vehicle to perform the power supply according to a verification result; and
performing, by the processor, the payment in response to completing the power supply.

20. The charging management method of claim 19, wherein the performing of the payment includes:
generating, by the processor, payment information based on the payment request message received from the first electric vehicle; and
transmitting, by the processor, the charging service and the payment information to an external server.
